(19) United States
(12) Patent Application Publication
(10) Pub. No.: US 2018/0108352 A1
(43) Pub. Date: Apr. 19, 2018

(54) Robot Interactive Communication System

(71) Applicant: Hitachi, Ltd., Tokyo (JP)

(72) Inventor: Takashi SUMIYOSHI, Tokyo (JP)

(21) Appl. No.: 15/730,194

(22) Filed: Oct. 11, 2017

(30) Foreign Application Priority Data
Oct. 18, 2016 (JP) 2016-204449

(51) Int. Cl. G10L 15/22; G06F 17/21

(52) U.S. Cl. CPC G10L 15/22; G06F 17/21; G10L 2015/227; G10L 2015/223; G10L 2015/221

(57) ABSTRACT

A robot interactive communication system includes a robot being configured to interact with a user, an environment sensor being configured to detect an environmental condition of the space. The robot includes a speech information-based interaction unit, a text information-based interaction unit, scenarios in which content lists are specified in advance, score information in which evaluation values for type of interaction included in the content lists are specified in advance and alternative action information in which alternative action to type of interaction included in the content lists are specified in advance. The robot is configured to select a content list from the scenarios depending on interaction with the user and is configured to calculate a value of the environmental condition based on information acquired from the environment sensor.

### CLAIM OF PRIORITY

The present application claims priority from Japanese patent application JP 2016-204449 filed on Oct. 18, 2016, the content of which is hereby incorporated by reference into this application.

### BACKGROUND

This invention relates to an interactive communication system for a robot that provides service through communication with the user.

In recent years, service robots have been developed that share the space with humans to provide various services. The engineers (hereinafter, service developers) who develop the services to be provided by the service robots often use development environments and scenario building tools provided by the manufacturers of the service robots in their development work. The service developers having good knowledge of service robots are provided with low-level application program interfaces (API). The service developers who is not very knowledgeable about service robots are provided with scenario building tools for describing services in a simple language or a graphical user interface (GUI). To grow the service robot market, facilitation of service development is an important factor.

A service robot is expected to act as intended by the service developer and further, to respond appropriately to the situation. The situation includes the condition of the robot itself, the condition of the user, and other environmental conditions.

For example, JP 2006-172280 A discloses an automated response creation method that determines the situation based on the information acquired through communication and outputs the determined situation.

For example, WO 2014/073612 and WO 2014/073613 disclose conversation-sentence generation methods that determine the condition of the user or the agent and generate a response suitable for the condition.

For example, JP 2012-048333 A discloses storing environmental data acquired by a sensor as a database, inferring the user's action based on the stored data, generating a dialog for the user, and determining information from the response from the user.

For example, JP 2010-509679 A discloses an on-line virtual robot that detects an inappropriate chat from chats among users and provides mediation, for example by issuing a warning.

### SUMMARY

The service robot asks what the user wants and provides information based on the request. In this operation, the service robot acquires information on the user, and selects and provides more appropriate information based on the acquired information to increase the satisfaction of the user.

When a service developer not familiar about the service robot develops the service with a scenario building tool, the service developer may not be able to sufficiently presume the situations to be faced by the service robot and the user; the service robot may act inappropriately because of this reason.

For example, the service robot may ask a question about a sensitive personal matter in an environment where other people exist, which results in undermining the satisfaction of the service user. Such an inappropriateness is likely to occur when a user interaction through an existing web service or terminal is directly applied to the service of a robot without any arrangement.

The service developer therefore needs to study the appropriate way to acquire information to be utilized in the service. It costs significantly for the service developer who is not familiar about the service robot to build up scenarios with a scenario building tool while considering possible situations the service robot will be placed for each question and it is unrealistic.

The aforementioned JP 2006-172280 A discloses an automated response creation method to output a situation determined from the conversation; however, it does not provide a method for the service robot to act appropriately in view of the speech to be made by the service robot and the situation the robot is placed.

The techniques of WO 2014/073612 and WO 2014/073613 create a response based on the determination of the internal condition of the user or the agent; however, neither of them provides a method of controlling the act of the service robot based on the information the service robot is to acquire or the environmental condition the service robot is placed.

The technique of JP 2012-048333 A infers a previous situation of the user based on the data acquired by a sensor and checks whether the inference is correct through interaction with the user; however, it does not provide a method of controlling the act of the service robot based on the information the service robot is to acquire or the environmental condition the service robot is placed. JP 2010-509679 A detects an inappropriate situation online and displays a warning; however, it does not refer to application of environmental information that can be utilized by the service robot or alternative action.

This invention has been accomplished in view of the above-described problems and aims to avoid an inappropriate action of the service robot described in a scenario created by a service developer.

A representative aspect of the present disclosure is as follows. A robot interactive communication system comprising: a robot including a processor and a storage device, the robot being configured to interact with a user; an environment sensor installed in a space where the robot is provided, the environment sensor being configured to detect an environmental condition of the space; and a network configured to connect the environment sensor and the robot, wherein the robot includes: a speech information-based interaction unit configured to interact with the user using speech information; a text information-based interaction unit configured to interact with the user using text information; scenarios in which content lists are specified in advance; each content list including a type of interaction, an attribute of interaction, and specifics of action to control the robot; score information in which evaluation values for type of interaction included in the content lists are specified in advance depending on values of the environmental condition and attributes of interaction; and alternative action information in which alternative action to type of interaction included in the content lists are specified in advance, wherein the processor is configured to select a content list from the scenarios depending on interaction with the user, wherein the processor is configured to calculate a value of the environmental condition based on information acquired from the environment sensor, wherein the processor is configured to change the type of interaction included in the selected content list to alternative action with reference to the alternative action information to create second content lists each including an alternative action that has replaced the type of interaction in the content list, wherein the processor is configured to calculate an evaluation value for each alternative action with reference to the score information, based on the attribute of interaction included in the created second content lists and the value of the environmental condition, and wherein the processor is configured to select a second content list including an alternative action taking the highest evaluation value.

This invention enables a robot to automatically avoid an inappropriate action described in a scenario created by a service developer based on the environmental information, achieving appropriate acquisition of information and providing a service based on the information.

### BRIEF DESCRIPTION OF THE DRAWINGS

FIG. 1 is a schematic diagram for illustrating a mobile robot interactive communication system according to a first embodiment of this invention.

FIG. 2 is a block diagram for illustrating an example of a mobile robot interactive communication system according to the first embodiment of this invention.

FIG. 3 is a flowchart for illustrating an example of the main program to be executed in the service robot according to the first embodiment of this invention.

FIG. 4 is a diagram for illustrating an example of the score table according to the first embodiment of this invention.

FIG. 5 is a diagram for illustrating an example of the alternative action table according to the first embodiment of this invention.

FIG. 6 is a diagram for illustrating an example of the scenarios according to the first embodiment of this invention.

FIG. 7 is a block diagram for illustrating an example of a mobile robot interactive communication system according to a second embodiment of this invention.

FIG. 8 is a block diagram for illustrating an example of a mobile robot interactive communication system according to a third embodiment of this invention.

### DETAILED DESCRIPTION OF THE EMBODIMENTS

Hereinafter, embodiments of this invention are described based on the accompanying drawings.

### Embodiment 1

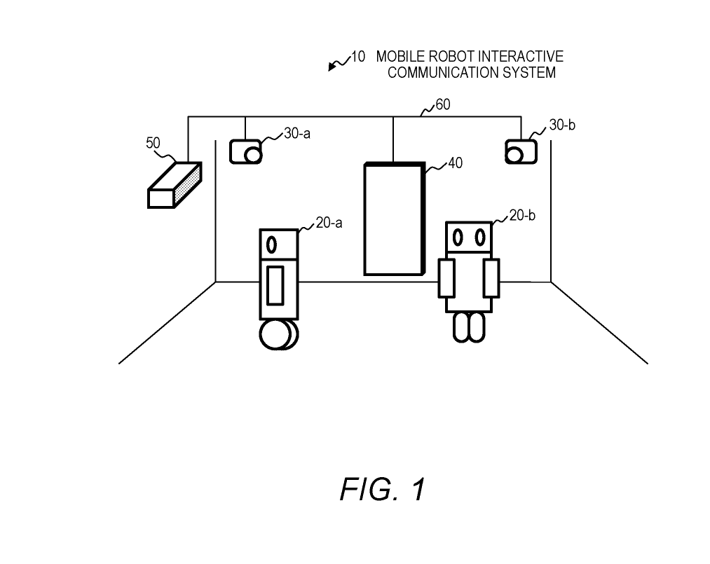

An embodiment of a mobile robot interactive communication system is described. FIG. 1 is a schematic diagram for illustrating the first embodiment of a mobile robot interactive communication system 10.

The mobile robot interactive communication system 10 includes service robots 20-a and 20-b, environment cameras 30-a, and 30-b, a display device 40, and a wireless access point 50. To generally describe a service robot, a reference numeral 20 is used in which the suffix following “-” is omitted. The same applies to the reference numerals for the other elements.

The environment cameras 30, the display device 40, and the wireless access point 50 are installed in the working space of the service robots 20, provide a wireless network, and are connected to the service robots 20 via the wireless network. Each service robot 20 works in accordance with scenarios provided by the service developer while grasping the current environmental conditions of the space based on the information from a sensor mounted on the service robot 20 and images taken by the environment cameras 30.

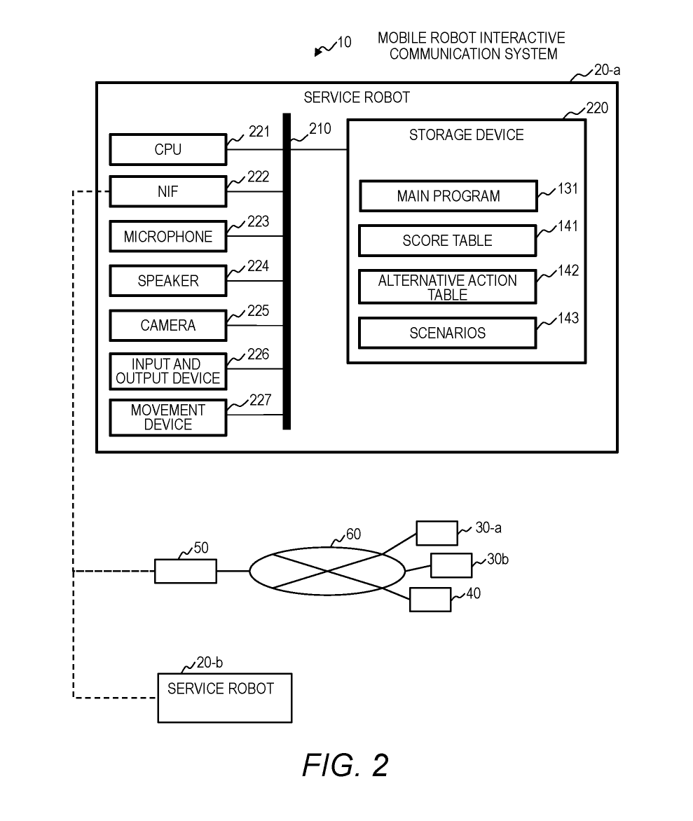

The environment cameras 30, the display device 40, and the wireless access point 50 are connected by a wired network 60 (see FIG. 2) supporting TCP/IP protocol; the service robots 20 are connected to the TCP/IP network 60 via the wireless access point 50 to be able to communicate with each other. The environment cameras 30 can be commercially-available web cameras and include a device to send an acquired motion image or still image to a service robot 20. The display device 40 can be a commercially-available signage apparatus and includes a device to display specified information on the screen in response to an instruction from a service robot 20.

FIG. 2 is a block diagram for illustrating an example of a mobile robot interactive communication system.

The bus 210 of the service robot 20-a interconnects a CPU 221, a network interface (NIF in the drawing) 222, a microphone (audio information input device) 223, a speaker (audio information output device) 224, a camera 225, an input and output device 226, a movement device 227, and a storage device 220 to transmit data signals; the bus 210 can employ a standard (such as PCI) for general-use PCs. The service robot 20-b has the same configuration; accordingly, duplicate description is omitted here.

The CPU 221 executes programs loaded to the storage device 220 and outputs predetermined signals to the movement device 227, the speaker 224, and the input and output device 226 based on the information (audio information or image information) acquired from the microphone 223 or the camera 225 to control the service robot 20. The CPU 221 can be a general-use CPU or a chip controller.

The microphone 223 is an audio information input device for collecting (or inputting) the sounds around the service robot 20 or the voice of the user. The microphone 223 can be a commercially-available capacitor microphone and an A/D converter.

The speaker 224 is an audio information output device for outputting an inquiry to the user or a response to the user from the service robot 20. The microphone 223 and the speaker 224 comprise a speech information-based interaction unit that communicates with the user by speech.

The camera 225 takes a video or an image of the periphery of the service robot 20. An image recognition unit of a main program 131 performs user recognition and calculation of the congestion degree of the space based on the image information acquired by the camera 225.

The network interface (NIF in the drawing) 222 is connected to the wireless access point 50 to communicate with an environment camera 30 for detecting an environmental condition (such as congestion degree) of the space where the service robot 20 is provided or the display device 40. The service robot 20 determines the condition of the periphery of the service robot 20 from not only the image information acquired from its own camera 225 but also the image information acquired from the environment cameras 30 to accurately determine the environmental condition of the space where the service robot 20 is provided. The service robot 20 can output image information to the display device 40 provided in the space when the service robot 20 uses the image information for a response to the user.

The environment sensors for detecting environmental conditions like congestion degree in the space where the service robots 20 are provided can include microphones for detecting noise and/or motion sensors for detecting motion of a living body, in addition to the environment cameras 30 provided in the space. These environment sensors are installed in a plurality of locations in the space and connected to the network 60. In particular, it is preferable that environment sensors be installed in the space so that some of the environment sensors can detect the congestion degree at a specific place (A) to which the service robots 20 are directed to move.

The input and output device 226 can be a display device with a touch panel and a printer to be used in communication with the user. The input and output device 226 can be used to display or print image or text information or to input text information when it is undesirable to use speech information in the communication with the user, for example. The input and output device 226 is a text information-based interaction unit. The text information-based interaction unit may include the display device 40.

The movement device 227 includes a motor and a controller for moving the service robot 20 in the space.

The storage device 220 is to store programs and data, and can be a commercially-available DRAM, HDD, or SSD.

The storage device 220 stores a main program 131 for controlling the service robot 20, a score table 141 in which scores (evaluation values) are preset depending on the type of interaction to be taken and the environmental condition, an alternative action table 142 in which alternative action to type of interaction to be taken are preset, and scenarios 143 in which content lists including the type of interaction to be taken, the attribute of the interaction, and specifics of actions are preset.

The foregoing description has provided an example where the microphone 223 and the camera 225 are used as sensors of the service robot 20; however, the sensors are not limited to these. The service robot 20 can include various sensors such as a temperature sensor, a motion sensor, an acceleration sensor, a location sensor, a photometer, and a touch sensor.

The main program 131 includes modules for image recognition, speech recognition, and/or moving object recognition depending on the sensors mounted on the service robot 20 to recognize sensor information.

The CPU 221 performs processing in accordance with the programs for function units to work as the function units for providing predetermined functions. For example, the CPU 221 performs processing in accordance with the main program 131 to function as a robot controller. The same applies to the other programs. The CPU 221 also works as function units for providing the functions of a plurality of processes executed by each program. The service robot and the interactive communication system are an apparatus and a system including these function units.

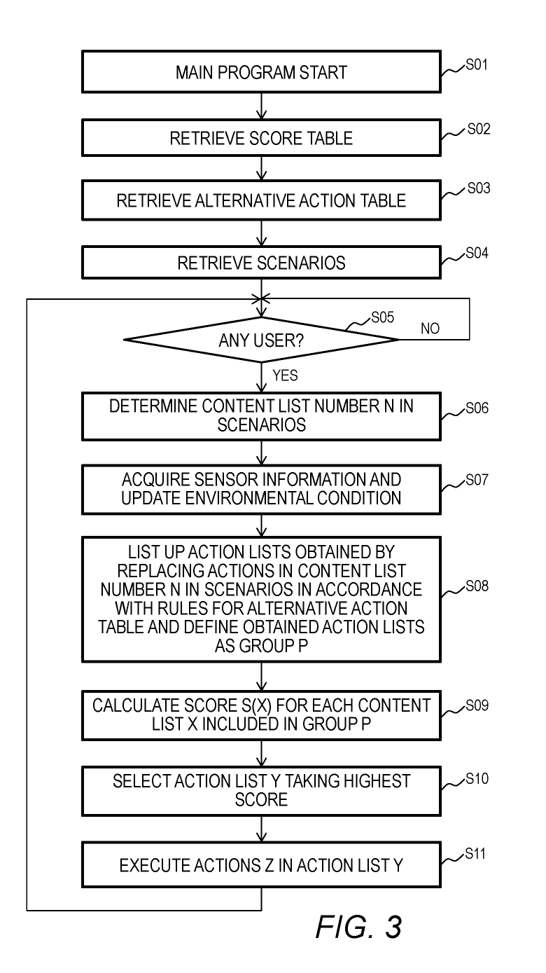

FIG. 3 is a flowchart for illustrating an example of the main program 231 to be executed in the service robot 20.

The main program 131 is started after activation of the service robot 20 (S01). The main program 131 retrieves the score table 141 from the storage device 220 (S02). Next, the main program retrieves the alternative action table 142 from the storage device 220 (S03). Next, the main program 131 retrieves the scenarios 143 from the storage device 220 (S04).

The main program 131 determines whether a user is present based on the sensor information from the sensors such as the camera 225, the microphone 223, and the input and output device 226. If a user is present, the main program 131 proceeds to Step S06 and if not, stands by. Whether a user is present can be determined by a known or well-known technique such as image recognition or speech recognition; accordingly, description is omitted herein.

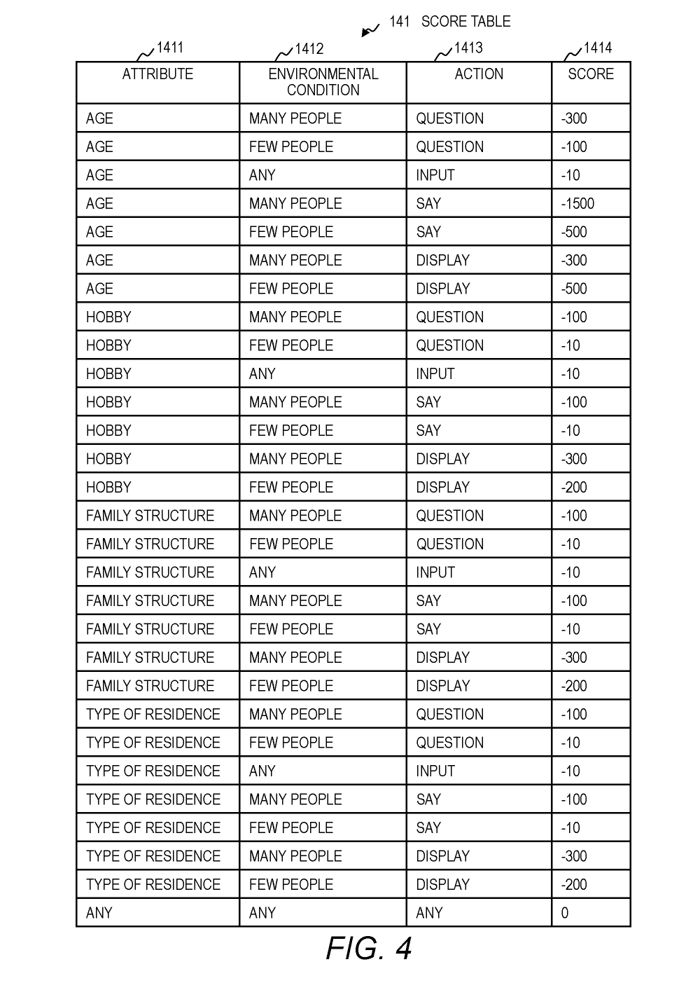

FIG. 4 is a diagram for illustrating an example of the score table 141 in the service robot 20.

The score table 141 is a table of a relational database. Each record of the score table 141 includes an attribute 1411 for storing the attribute of interaction, an environmental condition 1412 for storing an environmental condition around the service robot 20, an action 1413 for storing a type of interaction, and a score 1414 for storing a predetermined evaluation value for the action 1413 depending on the attribute and the environmental condition. The score table 141 defines a score 1414 with three keys of information: an attribute 1411 as a condition on the attribute, an environmental condition 1412 as a condition on the environment, and an action 1413 as a condition.

The condition on the attribute is the condition to be satisfied by the attribute assigned to a specific action (interaction) in the later-described scenarios 143. The condition on the environment is the condition to be satisfied by the environmental condition that can be acquired by the service robot 20. The condition is the condition on the type of interaction given in a content list 1432 in the later-described scenarios 143.

Examples of the type of interaction include: QUESTION for the service robot 20 to make an inquiry by speech and convert the information spoken by the user to a variable by speech recognition; CASE for the service robot 20 to determine an content list number 1431 in the scenarios 143 to jump to in accordance with the value of a variable; SAY for the service robot 20 to provide information by speech; GOTO for the service robot 20 to jump to a different content list number 1431 in the scenarios 143; GUIDETO for the service robot 20 to escort the user to a specified location; INPUT for the service robot 20 to acquire information from the user through the input and output device 226; DISPLAY_SENTENCE for the service robot 20 to provide information through the input and output device 226 or the display device 40; and PRINTOUT for the service robot 20 to provide information by printing out the information on a sheet of paper. The score table 141 is configured in advance in accordance with the policies of the service provider, independently from the kind of the service.

The condition “MANY PEOPLE” or “FEW PEOPLE” in an environmental condition 1412 can be determined by comparing the number of people calculated based on the data acquired from the sensors with a predetermined threshold.

Other than the number of people, the density of people in the space may be calculated as congestion degree for the environmental condition 1412; if the congestion degree is not lower than a predetermined threshold, the service robot 20 can determine the environmental condition 1412 to be crowded (MANY PEOPLE) and if lower than the threshold, determine the environmental condition 1412 to be not crowded (FEW PEOPLE). The congestion degree can be calculated by a known or well-known technique using image information acquired from a plurality of environment cameras 30.

The environmental condition 1412 may be BRIGHT or DARK calculated from the light intensity at the location of the service robot 20; if the light intensity is not lower than a threshold, the condition is determined to be BRIGHT and if lower than the threshold, determined to be DARK. Depending on whether the location of the service robot 20 is bright or dark, the device to provide information may be switched between the input and output device 226 and the display device 40.

The environmental condition 1412 may be NOISY or QUIET calculated from the volume of the noise captured by the microphone 223 at the location of the service robot 20; if the noise level is not lower than a threshold, the condition is determined to be NOISY and if lower than the threshold, determined to be QUIET. Depending on whether the location of the service robot 20 is noisy or quiet, the device to provide information may be switched between the speaker 224 and the input and output device 226 or the display device 40.

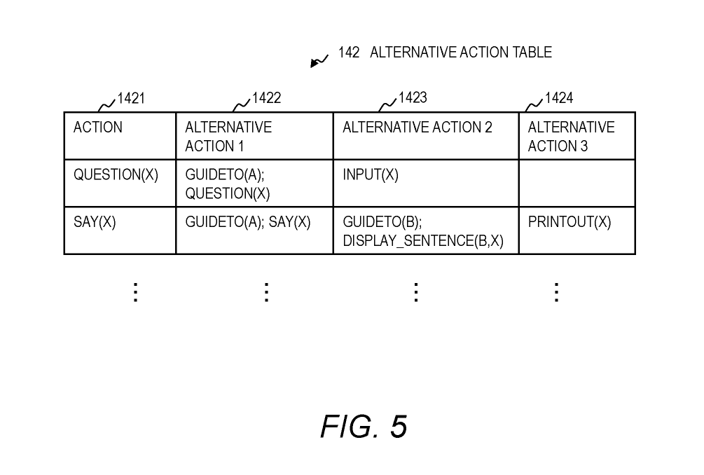

FIG. 5 is a diagram for illustrating an example of the alternative action table 142 in the service robot 20.

Each row of the alternative action table 142 is a group of action lists. Action lists replaceable with one another are defined as a group of action lists. The action 1421 stores an action to be replaced by another action. Each of the alternative action 1422 to 1424 stores an action (action list) to replace the action 1421. Although the example of FIG. 5 provides three alternative action at maximum, the number of alternative action is not limited to this.

An action list may include a plurality of action. In the example of FIG. 5, a plurality of action are separated by semicolons. The alternative action table 142 is created depending on the service robot 20 or the kinds of the device available to be used with, such as the environment camera 30 and the display device 40, but independently from the kind of the service.

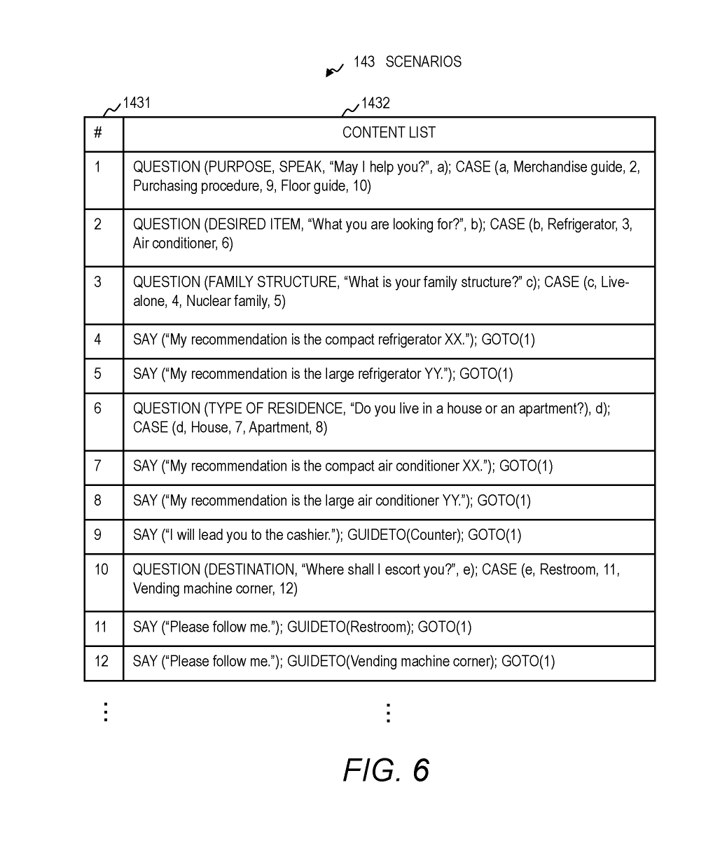

FIG. 6 is a diagram for illustrating an example of the scenarios 143 in the service robot 20.

Each row of the scenarios 143 includes a content list number 1431 and a content list 1432. The content list 1432 is a list of actions to be made by the service robot 20 for a user, including one or more actions separated by semicolons in FIG. 6. An action in a content list 1432 is comprised of a type of interaction and specifics of the action. The specifics of the action can include an attribute of the interaction.

As described above, the type of interaction indicates an action to be made by the service robot 20, such as SAY for providing information by speech. The specifics of the action indicate the specifics of the speech or text information, such as “My recommendation is the compact refrigerator XX”. The attribute of the interaction is information indicating which category the interaction relates to, such as PURPOSE, FAMILY STRUCTURE, TYPE OF RESIDENCE, or DESTINATION shown in FIG. 6. The scenarios 143 are created by the service developer and loaded to the service robot 20 in advance.

Returning to FIG. 3, the description of the main program 131 is continued. The main program 131 determines a content list number 1431 to be executed from the scenarios 143 through aforementioned image recognition or speech recognition on the above-described information acquired from the sensor such as the camera 225 or the microphone 223 and assigns the content list number to a variable N (S06).

For example, in the case of the first communication with the user, the main program 131 selects the content list #1 from the content list numbers 1431, speaks to the user “May I help you?”, and selects a content list number 1431 in accordance with the response from the user.

According to the content list #1 in the content list numbers 1431 in FIG. 6, if the response from the user is a request for “Merchandise guide”, the main program 131 proceeds to the content list #2 in the content list numbers 1431, if the response is a request for “Purchasing procedure”, proceeds to the content list #9 in the content list numbers 1431, and if the response is a request for “Floor guide”, proceeds to the content list #10 in the content list numbers 1431.

In the following operation, the main program 131 selects a content list number 1431 in the scenarios 143 and makes an action in accordance with the interaction with the user.

The main program 131 acquires image information from the sensor in the service robot 20 and the environment cameras 30, calculates the current environmental condition, and updates the environmental condition (S07). The information to be acquired by the main program 131 can include the number of people in the space, the volume of the noise, the light intensity of the illumination, and the location of the service robot 20. Instead of the number of people in the space, an indicator such as congestion degree may be employed for an environmental condition.

Next, the main program 131 acquires the content list 1432 associated with the variable N representing a row of the scenarios 143. The main program 131 selects the action in the acquired content list 1432 and searches the alternative action table 142 for a record including the selected action in the action 1421.

The main program 131 acquires the alternative action 1422 to 1424 from the record detected in the alternative action table 142 as actions (alternative action of interaction) replaceable in accordance with rules for alternative action. The main program 131 creates new content lists by replacing the action in the content list 1432 with the acquired alternative action and defines the created new content lists as a group P of replaced content lists (S08). The group P may include the content list 1421 before being replaced to be used in later-described comparison.

Next, the main program 131 calculates a score S(X) for each of the action lists X in the group P (S09). The score S(X) is defined as follows:

S(X)=S(x1)+ . . . +S(xi) (1)

where xi represents the i-th action in the action list X, and S(xi) is calculated from the action p and the specifics q. Specifically, the main program 131 acquires the action and the specifics (attribute) of the i-th action in the action list X, consults the score table 141 to acquire the score 1414 of the entry matching the action 1413 and the attribute 1411, and calculates S(xi). The main program 131 sums up the scores 1414 of all the actions x1 to xi in the action list X to calculate the total sum S(X) of the scores S(x1) to S(xi).

In the case of the action p=QUESTION, the specifics q are comprised of an attribute, the text of the question, and a result assignment variable, and S(xi)=−length (the text of the question). In the case of p=SAY, the specifics q are comprised of the text of the speech and S(xi)=−length (text of the speech). In the case of p=GUIDETO, the specifics q are comprised of the identifier of a place and S(xi)=−distance (the identifier of the place)*10. In the case of p=INPUT, the specifics q are comprised of an attribute, the text of a question, and a result assignment variable, and S(xi)=−length (the text of the question)*0.1.

In the case of p=DISPLAY_SENTENCE, the specifics q are comprised of the identifier of a display device and the text to be presented and S(xi)=−length (the text to be presented)*0.01.

In the case of p=PRINTOUT, the specifics q are comprised of the text to be presented and S(xi)=−length (the text to be presented)*2. In the cases of the other action, S(xi)=0. In the above description, the length(q) represents the text length of q and the distance(q) represents the distance from the current location to the point indicated by the locational identifier q.

This invention is not limited to the foregoing score calculation formulae. Any formulae are applicable. This invention is not limited to the embodiment with respect to the information to be used to calculate a score. For example, if displaying information on a screen is determined to be inappropriate because the display device is in use, another variable representing an environmental condition may be incorporated into the environmental condition 1412 to be taken account of so that the value of S(xi) will be adjusted to a smaller value.

Next, the main program 131 selects the action list X that takes the highest score S(X) (in the case of a negative value, the smallest absolute value) among the action lists X in the group P for which the total sums are calculated and determines the selected action list X to be an action list Y (S10).

The main program 131 finally executes the actions Z in the action list Y (S11).

Regarding the action p and the specifics q of an action Z, in the case of the action p=QUESTION, the specifics q are comprised of an attribute, the text of the question, and a result assignment variable. The main program 131 reproduces the question, recognizes the answer by speech through the microphone 223 with a not-shown speech recognition engine, and assigns the result of the speech recognition to the result assignment variable.

The speech recognition engine can be a commercially-available speech recognition engine or a speech recognition service on the web. In the case where the speech recognition engine needs to be provided with a dictionary or a grammar, it should be included in the specifics q to be provided.

In the case of the action p=CASE, the specifics q are comprised of a variable and a list of values of the variable and content list numbers 1431 to jump to. The main program 131 compares the variable with the values of the variable in the list and assigns the content list number 1431 associated with the match to the variable N.

In the case of the action p=SAY, the specifics q are comprised of the text of speech; the main program 131 reproduces the speech. In the case of p=GOTO, the specifics q are comprised of a content list number 1431; the main program 131 assigns the content list number to the variable N.

In the case of the action p=GUIDETO, the specifics q are comprised of the identifier of a place; the main program 131 moves the service robot 10 to escort the user to the place indicated by the identifier. The escorting can include speaking to the user or checking whether the user is following and if not, stopping the movement and speaking to the user, for example.

In the case of p=INPUT, the specifics q are comprised of an attribute, the text of a question, and a result assignment variable; the main program 131 displays the question on the input and output device 226 of the service robot 20 and requests the user to answer the question. The main program 131 assigns the answer from the user to the result assignment variable.

In the case of p=DISPLAY_SENTENCE, the specifics q are comprised of the identifier of a display device and a text to be presented; the main program 131 sends a command to the display device 40 (or the input and output device 226) designated by the identifier to output the text to be presented.

In the case of p=PRINTOUT, the specifics q are comprised of a text to be presented; the service robot 20 prints out the text on a sheet of paper with the printer of the input and output device 226 and provides the paper sheet to the user.

Hereinafter, a specific example of service provided by the service robot 20 is described. Described is a case where the service robot 20 serving a user asks about the family structure in accordance with QUESTION(X) in the content list of content list number 1431=3 in the scenarios 143.

The main program 131 calculates the number of people in the space or the periphery of the service robot 20 from the information acquired from the camera 225 and the environment cameras 30, determines MANY PEOPLE or FEW PEOPLE for the environmental condition 1412, and updates the environmental condition (S07). In this example, assume that MANY PEOPLE is determined for the environmental condition 1412.

Next, the main program 131 searches the alternative action table 142 with the action p=QUESTION(X) and selects “GUIDETO(A); QUESTION(X)” in the alternative action 1422 and “INPUT(X)” in the alternative action 1423. The main program 131 creates action lists X for the group P from the selected alternative action and the action p. The action lists X of the group P are comprised of an action list including the action of “QUESTION(X)”, an action list including the action of “GUIDETO(A); QUESTION(X)”, and an action list including the action of “INPUT(X)” (S08).

The main program 131 acquires the environmental condition 1412=MANY PEOPLE and acquires the scores 1414 associated with the attribute 1411=FAMILY STRUCTURE for the action in the action lists X. In this example, since “GUIDETO(A)” is not included in the score table 141, the score S(X) of each action list X becomes the value of a single action 1413.

The score 1414 of QUESTION(X) associated with FAMILY STRUCTURE and MANY PEOPLE is −100; that is, the total sum score S(X)=−100.

In the case of “GUIDETO(A); QUESTION(X)”, the main program 131 acquires the number of people at the place of the specified locational identifier (A) from the environment cameras 30, compares it with a threshold, and determines the environmental condition to be FEW PEOPLE. Accordingly, the score 1414 of “GUIDETO(A); QUESTION(X)” associated with FAMILY STRUCTURE and FEW PEOPLE is −10; that is, the score S(X)=−10.

The environmental condition 1412 for FAMILY STRUCTURE associated with INPUT(X) is ANY where no condition is provided for the environmental condition 1412. Accordingly, the score 1414 is −10; that is, the score S(X)=−10.

Next, the main program 131 selects “GUIDETO(A); QUESTION(X)” and “INPUT(X)” including the highest score for the score S(X). If a plurality of entries take the highest value for the score S(X), the main program 131 selects the action list X whose cost (such as time or distance) is the lowest. In this example, GUIDETO(A) takes extra cost for the time to move to the specified place (A); accordingly, the main program 131 selects the action list X including INPUT(X) taking the lower cost and executes it as the action list Y.

Through this processing, the service robot 20 can change the original action list X for asking the user about family structure by speech to the action list Y for requesting the user to input the family structure with the input and output device 226. Instead of making the user answer personal information by speech in front of many people, changing the action depending on the environmental condition 1412 around the service robot 20 to the action list Y for requesting the user to input the answer with the input and output device 226 enables sensitive information like personal information to be handled smoothly. The same applies to the speech of the service robot 20. Instead of speaking up information related to the privacy of the user in front of many people, changing the action depending on the environmental condition 1412 around the service robot 20 to the action list Y for displaying or printing out the information to the input and output device 226 enables the sensitive information like personal information to be handled smoothly.

Regarding an action list including a type of interaction of SAY (AGE, SPEAK, “Your age is ZZ.”), many users do not like their age to be told in front of people. Accordingly, in the case where the action 1413 is SAY and the attribute 1411 is AGE, the score table 141 is configured such that the score 1414=−1500 when the environmental condition 1412 is MANY PEOPLE and such that the score 1414=−500 even when the environmental condition 1412 is FEW PEOPLE. This configuration reduces the probabilities for the total sum score S(X) to become highest, preventing the service robot 20 from speaking up the age and keeping the privacy of the user from the nearby people.

Further, regarding the action SAY, alternative action to the action that the service robot 20 speaks up at the current location are defined in the alternative action table 142: such as an alternative action 1422=GUIDETO(A); SAY(X), an alternative action 1423=GUIDETO(B); DISPLAY_SENTENCE(B, X), and an alternative action 1424=PRINTOUT(X).

According to “GUIDETO(A); SAY(X)”, the service robot 20 escorts the user to the specified place (A) and speaks up the specifics of (X) or the age. According to “GUIDETO(B); DISPLAY_SENTENCE(B, X)”, the service robot 20 escorts the user to the specified place (B) and displays the specifics of (X) or the age on the input and output device 226 or the display device 40. According to “PRINTOUT(X)”, the service robot 20 prints out the specifics of (X) with the input and output device 226 to provide it to the user at the current location of the service robot 20.

Preparing such alternative action in the alternative action table 142 enables the type of interaction to be replaced by another action 1422, 1423, or 1424 that can avoid outputting information (such as the age or a bank account number) the user does not want the nearby people to listen to by speech.

Configuring the mobile robot interactive communication system 10 as described above enables a service robot 20 to avoid an inappropriate action in the scenarios 143 created by a service developer by itself using the environmental (sensor) information, achieving appropriate service based on the acquired information.

### Embodiment 2

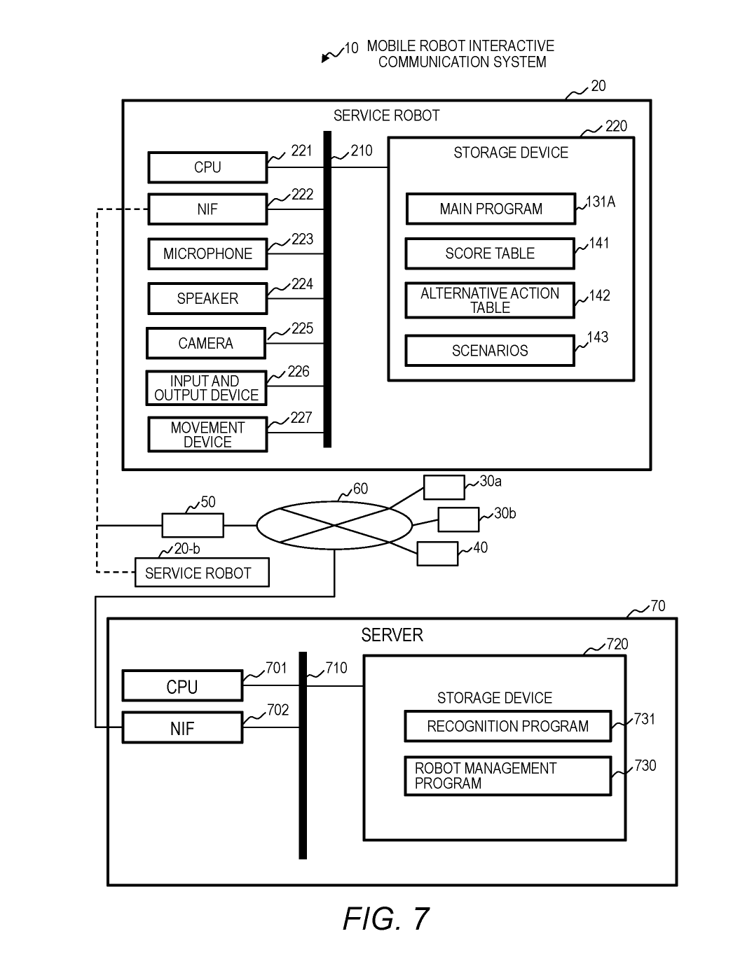

FIG. 7 is a block diagram for illustrating an example of a mobile robot interactive communication system 10, representing the second embodiment of this invention. The foregoing Embodiment 1 has provided an example where all sensor information is processed by the main program 131 of the service robot 20; Embodiment 2 provides an example where the service robot 20 delegates part of the processing to an external server 70.

Embodiment 2 provides an example where the processing performed by the service robot 20 in Embodiment 1 to recognize the sensor information by image recognition, speech recognition, and/or moving object recognition is performed by the server 70.

The service robot 20 has the same configuration as the one in Embodiment 1, except for the main program 131A. The main program 131A is different from the main program 131 of Embodiment 1 in the points that the processing to recognize sensor information, such as image recognition, speech recognition, and moving object recognition, is removed and the main program 131A requests the server 70 to perform the recognition processing. The main program 131A sends the sensor information from the microphone 223, the camera 225, and the environment cameras 30 to the server 70 to request recognition processing and receives results of the recognition to use them in calculating the environmental condition 1412 or other processing. Since the information from the environment cameras 30 can be acquired by the server 70, the service robot 20 has only to issue an instruction to acquire image information from the environment cameras 30 and process the image information.

The server 70 is a computer including a CPU 701, a network interface (NIF in the drawing) 702, and a storage device 720. The storage device 720 stores a robot management program 730 for managing a plurality of service robots 20 and a recognition program 731 for performing predetermined recognition processing on sensor information received from a service robot 20.

The main program 131A of the service robot 20 in Embodiment 2 instructs the server 70 to calculate the environmental condition at Step S07 in the flowchart of FIG. 3 in Embodiment 1. The server 70 acquires image information from the environment cameras 30, calculates the environmental condition such as the congestion degree, and sends the result to the service robot 20. The service robot 20 calculates the scores using the environmental condition received from the server 70.

In Embodiment 2, the recognition processing that causes high load to the CPU 221 of the service robot 20 is transferred from the main program 131A to the server 70 to achieve higher-speed processing in the service robot 20.

### Embodiment 3

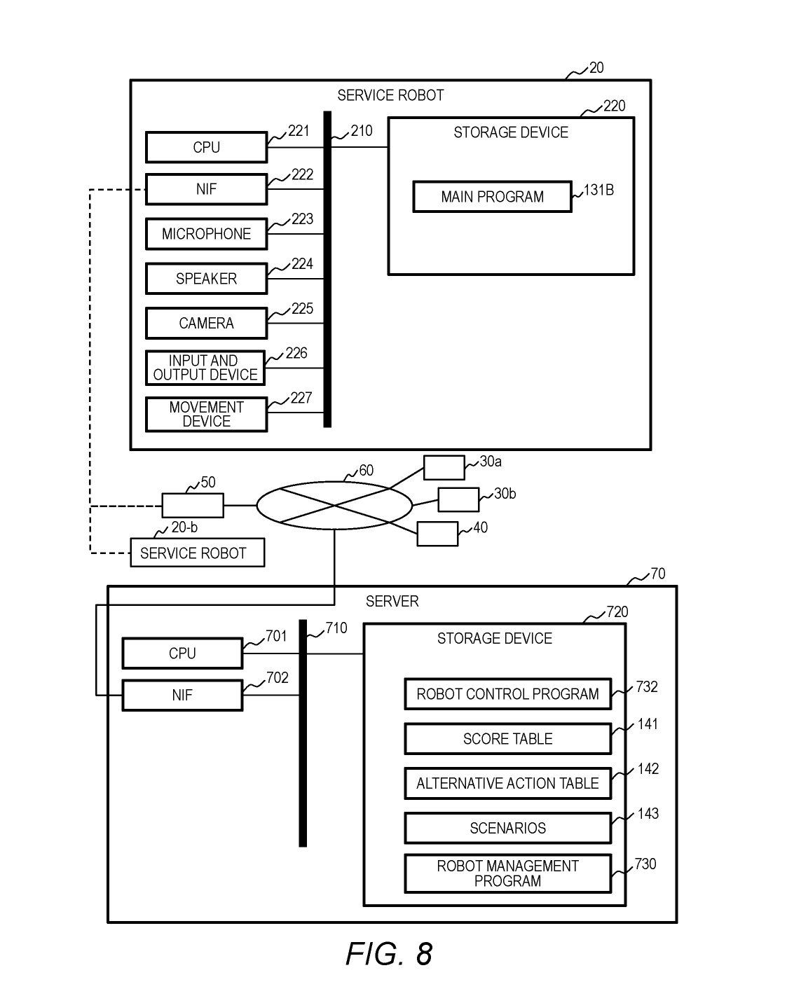

FIG. 8 is a block diagram for illustrating an example of a mobile robot interactive communication system 10, representing the third embodiment of this invention. The foregoing Embodiment 1 has provided an example where all sensor information is processed by the main program 131 of the service robot 20; Embodiment 3 provides an example where the service robot 20 delegates the processing to an external server 70.

Embodiment 3 provides an example where the processing performed by the service robot 20 in Embodiment 1, except for controlling the movement device 227, the input and output device 226, the camera 225, the speaker 224, and the microphone 223, is performed by the server 70.

The service robot 20 has the same configuration as the one in Embodiment 1, except for the main program 131B. The main program 131B is a program for performing controlling the movement device 227, the input and output device 226, the camera 225, the speaker 224, and the microphone 223 out of the processing to be performed by the main program 131 in Embodiment 1. Determining action lists X from the scenarios 143, updating the environmental condition, and calculating the scores S(X) are delegated to the server 70. In other words, the main program 131B performs controlling the camera 225, the speech information-based interaction unit, the text information-based interaction unit, and the movement device 227 and requests the server 70 to perform the other processing described in Embodiment 1.

The server 70 is a computer including a CPU 701, a network interface (NIF in the drawing) 702, and a storage device 720.

The storage device 720 stores a robot management program 730 for managing a plurality of service robots 20, a robot control program 732 for determining an action list Y from the sensor information received from a service robot 20 to send the action list to the service robot 20 as a response, the score table 141 shown in FIG. 4 of Embodiment 1, the alternative action table 142 shown in FIG. 5 of Embodiment 1, and the scenarios 143 shown in FIG. 6 of Embodiment 1. A service robot 20 sends sensor information to the server 70, receives an action list Y, and executes the action list Y.

Embodiment 3 can reduce the processing load of the service robot 20 by determining the control of the service robot 20 at the server 70, achieving simplification of the hardware and cost reduction in the service robot 20.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A robot interactive communication system comprising:
a robot including a processor and a storage device, the robot being configured to interact with a user;
an environment sensor installed in a space where the robot is provided, the environment sensor being configured to detect an environmental condition of the space; and
a network configured to connect the environment sensor and the robot,
wherein the robot includes:
a speech information-based interaction unit configured to interact with the user using speech information;
a text information-based interaction unit configured to interact with the user using text information;
scenarios in which content lists are specified in advance; each content list including a type of interaction, an attribute of interaction, and specifics of action to control the robot;
score information in which evaluation values for type of interaction included in the content lists are specified in advance depending on values of the environmental condition and attributes of interaction; and
alternative action information in which alternative action to type of interaction included in the content lists are specified in advance,
wherein the processor is configured to select a content list from the scenarios depending on interaction with the user,
wherein the processor is configured to calculate a value of the environmental condition based on information acquired from the environment sensor,
wherein the processor is configured to change the type of interaction included in the selected content list to alternative action with reference to the alternative action information to create second content lists each including an alternative action that has replaced the type of interaction in the content list,
wherein the processor is configured to calculate an evaluation value for each alternative action with reference to the score information, based on the attribute of interaction included in the created second content lists and the value of the environmental condition, and
wherein the processor is configured to select a second content list including an alternative action taking the highest evaluation value.

2. The robot interactive communication system according to claim 1, wherein the processor is configured to execute the selected second content list including an alternative action to interact using the speech information-based interaction unit or the text information-based interaction unit in accordance with the alternative action.

3. The robot interactive communication system according to claim 1, wherein the alternative action includes an alternative action to change interaction by the speech information-based interaction unit to interaction by the text information-based interaction unit and the text information-based interaction unit is configured to display or print out text information.

4. The robot interactive communication system according to claim 1,
wherein the content list includes one or more type of interaction,
wherein the second content lists are created by replacing each of the one or more type of interaction in the content list with an alternative action, and
wherein the processor is configured to select a second content list on which the total sum of the evaluation values for the alternative action is highest.

5. The robot interactive communication system according to claim 1, wherein the processor is configured to calculate a human congestion degree as the value of the environmental condition, based on information acquired by the environment sensor.

6. A robot interactive communication system comprising:
a robot including a processor and a storage device, the robot being configured to interact with a user;
an environment sensor installed in a space where the robot is provided, the environment sensor being configured to detect an environmental condition of the space;
a server including a processor and a storage device; and
a network configured to connect the server, the environment sensor, and the robot,
wherein the robot includes:
a speech information-based interaction unit configured to interact with the user using speech information; and
a text information-based interaction unit configured to interact with the user using text information,
wherein the processor of the robot is configured to send interaction with the user to the server with the speech information-based interaction unit or the text information-based interaction unit,
wherein the server includes:
scenarios including content lists specified in advance; each content list including a type of interaction, an attribute of interaction, and specifics of action to control the robot;
score information in which evaluation values of the type of interaction included in the content lists are specified in advance depending on values of the environmental condition and attributes of interaction; and
alternative action information in which alternative action to type of interaction included in the content lists are specified in advance,
wherein the processor of the server is configured to select a content list from the scenarios depending on the interaction with the user,
wherein the processor of the server is configured to calculate a value of the environmental condition based on information acquired from the environment sensor,
wherein the processor of the server is configured to change the type of interaction included in the selected content list to alternative action with reference to the alternative action information to create second content lists each including an alternative action that has replaced the type of interaction in the content list,
wherein the processor of the server is configured to calculate an evaluation value for each alternative action with reference to the score information, based on the attribute of interaction included in the created second content lists and the value of the environmental condition, and
wherein the processor of the server is configured to select a second content list including an alternative action taking the highest evaluation value.

7. The robot interactive communication system according to claim 6,
wherein the processor of the server is configured to send the selected second content list including an alternative action to the robot, and
wherein the processor of the robot is configured to execute the received second content list including an alternative action to interact using the speech information-based interaction unit or the text information-based interaction unit in accordance with the alternative action.

8. The robot interactive communication system according to claim 6, wherein the alternative action includes an alternative action to change interaction by the speech information-based interaction unit to interaction by the text information-based interaction unit and the text information-based interaction unit is configured to display or print out text information.

9. The robot interactive communication system according to claim 6,
wherein the content list includes one or more type of interaction,
wherein the second content lists are created by replacing each of the one or more type of interaction in the content list with an alternative action, and
wherein the processor of the server is configured to select a second content list on which the total sum of the evaluation values for the alternative action is highest.

10. The robot interactive communication system according to claim 6, wherein the processor of the server is configured to calculate a human congestion degree as the value of the environmental condition, based on information acquired by the environment sensor.

11. A robot interactive communication system comprising:
a robot including a processor and a storage device, the robot being configured to interact with a user;
an environment sensor installed in a space where the robot is provided, the environment sensor being configured to detect an environmental condition of the space;
a server including a processor and a storage device; and
a network configured to connect the server, the environment sensor, and the robot,
wherein the robot includes:
a speech information-based interaction unit configured to interact with the user using speech information;
a text information-based interaction unit configured to interact with the user using text information;
scenarios in which content lists are specified in advance; each content list including a type of interaction, an attribute of interaction, and specifics of action to control the robot;
score information in which evaluation values for type of interaction included in the content lists are specified in advance depending on values of the environmental condition and attributes of interaction; and
alternative action information in which alternative action to type of interaction included in the content lists are specified in advance,
wherein the processor of the robot is configured to select a content list from the scenarios depending on interaction with the user,
wherein the processor of the robot is configured to instruct the server to calculate a value of the environmental condition,
wherein the processor of the server is configured to calculate a value of the environmental condition based on information acquired from the environment sensor and send the value of the environmental condition to the robot,
wherein the processor of the robot is configured to change the type of interaction included in the selected content list to alternative action with reference to the alternative action information to create second content lists each including an alternative action that has replaced the type of interaction in the content list,
wherein the processor of the robot is configured to calculate an evaluation value for each alternative action with reference to the score information, based on the attribute of interaction included in the created second content lists and the value of the environmental condition, and
wherein the processor of the robot is configured to select a second content list including an alternative action taking the highest evaluation value.

12. The robot interactive communication system according to claim 11, wherein the processor of the robot is configured to execute the selected second content list including an alternative action to interact using the speech information-based interaction unit or the text information-based interaction unit in accordance with the alternative action.

13. The robot interactive communication system according to claim 11, wherein the alternative action includes an alternative action to change interaction by the speech information-based interaction unit to interaction by the text information-based interaction unit and the text information-based interaction unit is configured to display or print out text information.

14. The robot interactive communication system according to claim 11,
wherein the content list includes one or more type of interaction,
wherein the second content lists are created by replacing each of the one or more type of interaction in the content list with an alternative action, and
wherein the processor of the robot is configured to select a second content list on which the total sum of the evaluation values for the alternative action is highest.

15. The robot interactive communication system according to claim 11, wherein the processor of the server is configured to calculate a human congestion degree as the value of the environmental condition, based on information acquired by the environment sensor.
